(19) United States
(12) Patent Application Publication
(10) Pub. No.: US 2006/0039700 A1
(43) Pub. Date: Feb. 23, 2006

(54) Passive optical network

(75) Inventors: Hyun-Soo Kim, Suwon-si (KR); Dae-Kwang Jung, Suwon-si (KR); Jeong-Seok Lee, Anyang-si (KR); Sung-Kee Kim, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/005,212

(22) Filed: Dec. 6, 2004

(30) Foreign Application Priority Data
Aug. 20, 2004 (KR) 2004-66089

(51) Int. Cl. H04J 14/00

(52) U.S. Cl. 398/72

(57) ABSTRACT

A passive optical network using downstream and upstream optical signals for achieving a two-way communication is provided, wherein the downstream and upstream optical signals have different polarization components and an equal wavelength band.

### CLAIM OF PRIORITY

This application claims priority to an application entitled “Passive Optical Network,” filed in the Korean Intellectual Property Office on Aug. 20, 2004 and assigned Serial No. 2004-66089, the contents of which are incorporated herein by reference.

### BACKGROUND OF THE INVENTION

1. Field of the Invention

The present invention relates to a wavelength division multiplexing passive optical network(WDM-PON) and, more particularly, to a wavelength division multiplexing passive optical network for realizing a two-way communication.

2. Description of the Related Art

The WDM-PON provides an ultra high-speed broadband communication service by classifying specific wavelengths to each subscriber unit. Therefore, the WDM-PON can ensure the secrecy of communication and easily accommodate a new communication line by adding a separate wavelength to a new subscriber. At the same time, the WDM-PON has a disadvantage in that a central office and each optical network unit require both light sources having specific oscillation wavelengths and additional wavelength stabilization circuits for stabilizing the wavelengths of the light sources.

FIG. 1 is a block diagram illustrating a conventional PON. As shown, the conventional PON includes a central office 110, a remote node 120, and a plurality of optical network units 130. The central office 110 and the remote node 120 are connected to each other through a single optical fiber 101. The remote node 120 is connected to each of the optical network units 130, forming a double star structure.

More specifically, the central office 110 includes a plurality of downstream light sources 111 for generating downstream optical signals λ₁ to λ_{N}, a multiplexing/demultiplexing unit 113 for demultiplexing multiplexed upstream optical signals λ_{N+1} to λ_{2N} and for multiplexing the downstream optical signals, and an upstream light detector 112 for detecting upstream optical signals demultiplexed by the multiplexing/demultiplexing unit 113.

The remote node 120 includes a multiplexing/demultiplexing unit 121, which demultiplexes and outputs the downstream optical signals multiplexed in the central office 110, to a relevant optical network unit 130, and further multiplexes and outputs the upstream optical signals inputted from the optical network units 130 to the central office 110.

Each optical network unit 130 includes an upstream light source 132 for generating an upstream optical signal and a downstream light detector 131 for detecting a down optical signal demultiplexed in the remote node 120.

For a typical two-way communication, the PON uses downstream and upstream optical signals having different wavelength bands from each other. That is, since the central office 110 and the remote node 120 are linked to each other through a single optical fiber, the PON uses downstream and upstream optical signals having different wavelength bands from each other to minimize loss and noise generation due to interference between the upstream and downstream optical signals.

Meanwhile, when it is necessary to increase the number of lines according to the increase in the number of optical network units, the PON can increase as many lines as necessary by reducing the wavelength interval between the downstream optical signals and the wavelength interval between the upstream optical signals. However, as the wavelength interval are reduced to increase the number of lines in the conventional PON, a higher-price multiplexing/demultiplexing unit is required to stabilize the wavelength bands. Also, it is necessary to include an additional separate stabilizing means for stabilizing the wavelengths in the lines added according to the reduction of the wavelength. Accordingly, the conventional PON has a problem in that the cost of construction of a PON largely increases whenever extra lines are added.

### SUMMARY OF THE INVENTION

Accordingly, the present invention has been made to solve the above-mentioned problems occurring in the prior art and provides additional advantages, by providing an economical passive optical network.

In one aspect of the present invention, there is provided a passive optical network using a downstream optical signal and an upstream optical signal for a two-way communication, wherein the downstream optical signal and the upstream optical signal have different polarization components and an equal wavelength band.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating the construction of a conventional PON;

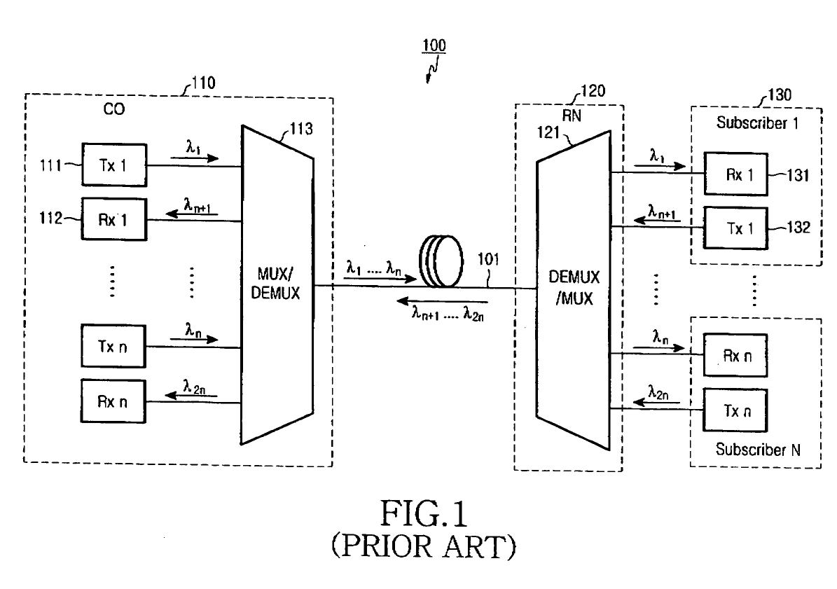

FIG. 2 is a block diagram illustrating the construction of a passive optical network according to an embodiment of the present invention; and

FIG. 3 is a block diagram illustrating the construction of a passive optical network according to another embodiment of the present invention.

### DETAILED DESCRIPTION

Hereinafter, embodiments of a passive optical network according to the present invention will be described with reference to the accompanying drawings. For the purposes of clarity and simplicity, a detailed description of known functions and configurations incorporated herein will be omitted as it may obscure the subject matter of the present invention.

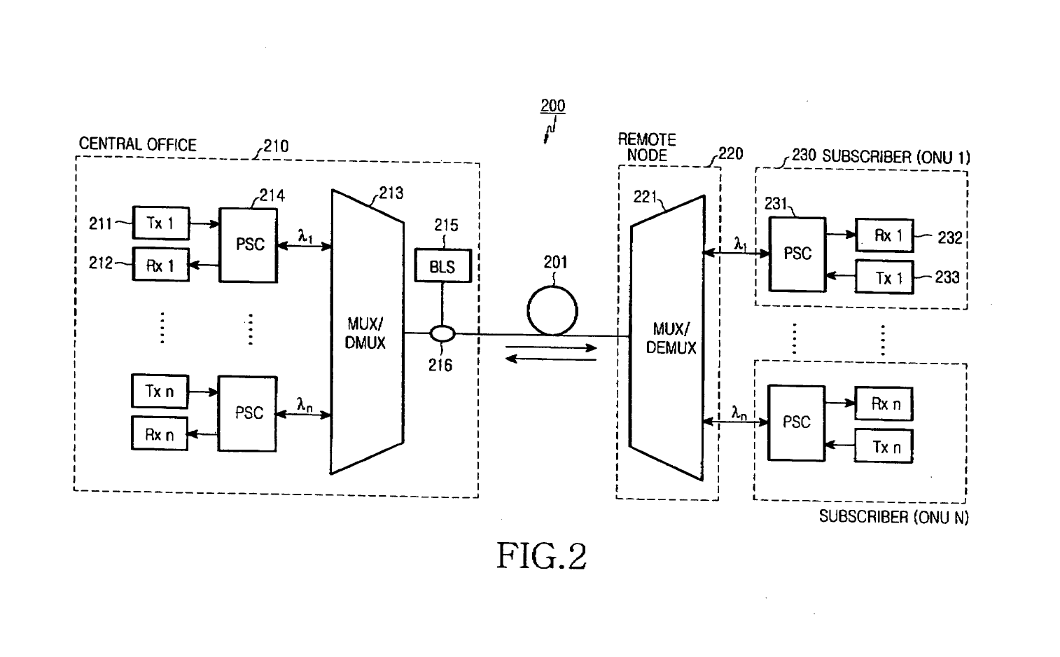

FIG. 2 is a block diagram illustrating the construction of a passive optical network according to a first embodiment of the present invention. As shown, the passive optical network includes a central office 210 for generating wavelength-locked downstream optical signals λ₁ to λ_{N} and detecting upstream optical signals λ₁ to λ_{N}, a plurality of optical network units 230 for generating upstream optical signals having a polarization component different from the downstream optical signals according to a wavelength locking scheme, and a remote node 220 connected to the central office 210 through a single optical fiber 201. The upstream optical signals and the downstream optical signals use the same wavelength band and different polarization components.

The central office 210 includes a plurality of downstream light sources 211 for generating wavelength-locked downstream optical signals, a plurality of upstream light detectors 212 for detecting demultiplexed upstream optical signals, a first multiplexing/demultiplexing unit 213, a first polarization selective coupler 214, a broadband light source 215, and a light coupler 216 located on the single optical fiber 201 to transmit broadband lights to the central office 210 and the remote node 220.

The broadband light source 215 generates a light having a wide wavelength band for wavelength-locking lights outputted from each of the optical network units 230 and the downstream light sources 211, and outputs the light to the first multiplexing/demultiplexing unit 213 and the remote node 220. The broadband light source 215 includes a semiconductor optical amplifier and a rare-earth element doped optical fiber that can generate amplified spontaneous emission light or incoherent light having a wide wavelength band.

The first multiplexing/demultiplexing unit 213 multiplexes downstream optical signals generated in the downstream light sources 211 to output the multiplexed downstream optical signals to the remote node 220 and demultiplexes the upstream optical signals to relevant upstream light detectors 212. In addition, the first multiplexing/demultiplexing unit 213 divides the light generated in the broadband light source 215 into incoherent channels having different wavelengths from each other and then inputs the respective incoherent channels to relevant downstream light sources 211. Each downstream light source 211 generates a wavelength-locked downstream optical signal using a corresponding incoherent channel. The downstream light sources 211 may include a Fabry-Perot laser and a reflective semiconductor optical amplifier.

The first polarization selective coupler 214 outputs a demultiplexed upstream optical signal to a relevant upstream light detector 212 and outputs a downstream optical signal generated in a relevant downstream light source 211 to the first multiplexing/demultiplexing unit 213. The first polarization selective coupler 214 includes a polarization beam splitter capable of splitting and coupling optical signals according to polarization components.

The remote node 220 includes a second multiplexing/demultiplexing unit 221, which is connected to the central office 210 through the single optical fiber 201 to demultiplex and output the multiplexed downstream optical signals to the relevant optical network units 230. It is also configured to multiplex and output upstream optical signals inputted from the optical network units 230 to the central office 210. The second multiplexing/demultiplexing unit 221 splits the light inputted through the light coupler 216 into incoherent channels having different wavelengths from each other and then outputs each of the incoherent channels to a relevant optical network unit 230. The single optical fiber 201 includes a polarization-maintaining optical fiber.

Each of the optical network units 230 includes a downstream light detector 232 for detecting a relevant optical signal demultiplexed in the remote node 220, an upstream light source 233 for generating a wavelength-locked upstream optical signal, and a second polarization selective coupler 231. The upstream light source 233 generates a wavelength-locked upstream optical signal by a relevant incoherent channel.

The second polarization selective coupler 231 outputs a relevant downstream optical signal demultiplexed in the remote node 220 to the downstream light detector 232 and outputs the upstream optical signal generated in the upstream light source 233 to the remote node 220. The second polarization selective coupler 231 includes a polarization beam splitter.

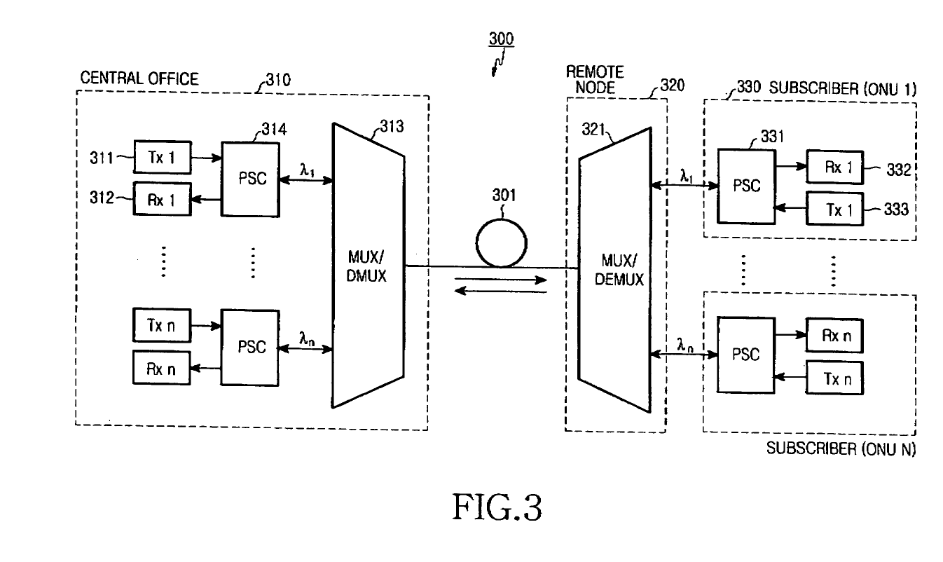

FIG. 3 is a block diagram illustrating the construction of a passive optical network according to a second embodiment of the present invention. As shown, the passive optical network includes a central office 310 for generating downstream optical signals and for demultiplexing and detecting multiplexed upstream optical signals, a plurality of optical network units 330 for generating upstream optical signals having a polarization component other than the polarization component of the downstream optical signals and for detecting relevant downstream optical signals having been demultiplexed, and a remote node 320 for intermediating between the central office 310 and the optical network units 330. The upstream optical signals and downstream optical signals λ₁ to λ_{N} use the same wavelength band and different polarization components. A single optical fiber 301 for connecting the central office 310 and the remote node 320 includes a polarization-maintaining optical fiber.

The central office 310 includes a plurality of downstream light sources 311 for generating downstream optical signals, a plurality of upstream light detectors 312 for detecting relevant upstream optical signals having been demultiplexed, a first multiplexing/demultiplexing unit 313, and a first polarization selective couplers 314.

Each of the downstream light source 311 may include a distributed feedback laser, and the downstream and upstream optical signals may have one from among wavelength bands of 1300˜1350 nm, 1450˜1500 nm, and 1520˜1620 nm.

The first multiplexing/demultiplexing unit 313 multiplexes downstream optical signals generated in the downstream light sources 311 to output the multiplexed downstream optical signals to the remote node 320, and demultiplexes the upstream optical signals having been multiplexed to output the demultiplexed upstream optical signals to relevant upstream light detectors 312. The first multiplexing/demultiplexing unit 313 includes an arrayed optical waveguide grating having a plane waveguide.

Each of the first polarization selective coupler 314 outputs a relevant upstream optical signal having been demultiplexed to a corresponding upstream light detector 312 and outputs a downstream optical signal generated in a relevant downstream light source 311 to the first multiplexing/demultiplexing unit 313. The first polarization selective coupler 314 may include a polarization beam splitter to input/output downstream and upstream optical signals having different polarization components from each other.

The remote node 320 includes a second multiplexing/demultiplexing unit 321. The second multiplexing/demultiplexing unit 321 is connected to the central office 310 through the single optical fiber 301 to demultiplex and output the multiplexed downstream optical signals to the relevant optical network units 330. It is further configured to multiplex and output upstream optical signals inputted from the optical network units 330 to the central office 310.

Each of the optical network units 330 includes a downstream light detector 332 for detecting a relevant downstream optical signal demultiplexed in the remote node 320, an upstream light source 333 for generating an upstream optical signal, and a second polarization selective coupler 331.

The second polarization selective coupler 331 outputs a relevant downstream optical signal demultiplexed in the remote node 320 to the downstream light detector 332 and outputs the upstream optical signal generated in the upstream light source 333 to the remote node 320. The second polarization selective coupler 331 includes a polarization beam splitter.

As described above, the passive optical network according to the present invention uses the upstream optical signals and the down optical signals having the same wavelength band and different polarization components, so that it is possible to increase lines at a low cost.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A passive optical network using a downstream optical signal and an upstream optical signal for a two-way communication, wherein the downstream optical signal and the upstream optical signal have different polarization components and an equal wavelength band.

2. A passive optical network comprising:
a central office for generating downstream optical signals having a first polarization component and demultiplexing upstream optical signals;
a plurality of optical network units for generating the upstream optical signals having a second polarization component and detecting the demultiplexed downstream optical signals; and
a remote node for multiplexing the upstream optical signals from the optical network units to the central office and demultiplexing the downstream optical signals from the central office to corresponding optical network units, wherein the downstream optical signals and the upstream optical signals have an equal wavelength band.

3. The passive optical network as claimed in claim 1, further comprising a single optical fiber having a polarization-maintaining optical fiber.

4. The passive optical network as claimed in claim 2, wherein, the central office comprises:
a plurality of downstream light sources for generating the downstream optical signals;
a plurality of upstream light detectors for detecting the upstream optical signals;
a first multiplexing/demultiplexing unit for multiplexing the downstream optical signals generated by the downstream light sources and outputting them to the remote node and for demultiplexing the upstream optical from the remote node to the corresponding upstream light detectors; and
a first polarization selective coupler for outputting the demultiplexed upstream optical signals to the corresponding upstream light detectors and for outputting the generated downstream optical signals to the first multiplexing/demultiplexing unit.

5. The passive optical network as claimed in claim 2, further comprising a broadband light source, wherein the first multiplexing/demultiplexing unit divides the light generated by the broadband light source into incoherent channels having different wavelengths from each other and then inputs them to the respective downstream light sources.

6. The passive optical network as claimed in claim 5, wherein each downstream light source generates a wavelength-locked downstream optical signal using the incoherent channel received thereon.

7. The passive optical network as claimed in claim 4, wherein the first polarization selective couplers include a polarization beam splitter.

8. The passive optical network as claimed in claim 4, wherein each of the downstream light sources includes a distributed feedback laser.

9. The passive optical network as claimed in claim 2, wherein the downstream optical signals and the upstream optical signals have a wavelength band of 1300˜1350 nm.

10. The passive optical network as claimed in claim 2, wherein the downstream optical signals and the upstream optical signals have a wavelength band of 1450˜1500 mn.

11. The passive optical network as claimed in claim 2, wherein the downstream optical signals and the upstream optical signals have a wavelength band of 1520˜1620 nm.

12. The passive optical network as claimed in claim 2, wherein the remote node includes a second multiplexing/demultiplexing unit coupled to the central office via an optical fiber for demultiplexing the downstream optical signals to the corresponding optical network units, and for multiplexing the upstream optical signals from the optical network units to the central office.

13. The passive optical network as claimed in claim 2, wherein each of the optical network units comprises:
a downstream light detector for detecting the corresponding downstream optical signal demultiplexed by the remote node;
an upstream light source for generating the upstream optical signals; and
a second polarization selective coupler for outputting the demultiplexed downstream optical signals from the remote node to the corresponding downstream light detector and for outputting the upstream optical signals generated by the upstream light source to the remote node.

14. A passive optical network comprising:
a central office for generating wavelength-locked downstream optical signals and for demultiplexing upstream optical signals;
a plurality of optical network units for generating the upstream optical signals having a polarization component different from the downstream optical signals using a wavelength locking scheme and for detecting the downstream optical signals; and
a remote node for multiplexing the upstream optical signals to the central office and for demultiplexing the down optical signals multiplexed by the central office to the corresponding optical network units, wherein the downstream optical signals and the upstream optical signals have an equal wavelength band.

15. The passive optical network as claimed in claim 14, wherein, the central office comprises:
a plurality of downstream light sources for generating the wavelength-locked downstream optical signals;
a plurality of upstream light detectors for detecting the demultiplexed upstream optical signals;
a first multiplexing/demultiplexing unit for multiplexing the generated downstream optical signals by the downstream light sources and outputting them to the remote node, and for demultiplexing the multiplexed upstream optical signals by the remote node and outputting them to the corresponding upstream light detectors;
a first polarization selective coupler for outputting the demultiplexed upstream optical signal to a corresponding upstream light detector and for outputting the downstream optical signals generated by the corresponding downstream light source to the first multiplexing/demultiplexing unit;
a broadband light source for generating a light having a wide wavelength band for wavelength-locking optical signals from each of the optical network units and the downstream light sources; and
a light coupler located on a single optical fiber to transmit the broadband light to the central office and the remote node.

16. The passive optical network as claimed in claim 15, wherein the downstream light source includes one of a Fabry-Perot laser and a reflective semiconductor optical amplifier.

17. The passive optical network as claimed in claim 14, wherein the remote node includes a second multiplexing/demultiplexing unit coupled to the central office via an optical fiber for demultiplexing the downstream optical signals to the corresponding optical network units, and for multiplexing the upstream optical signals from the optical network units to the central office.

18. The passive optical network as claimed in claim 17, wherein the single optical fiber includes a polarization-maintaining optical fiber.

19. The passive optical network as claimed in claim 14, wherein each of the optical network units comprises:
a downstream light detector for detecting the demultiplexed downstream optical signals from the remote node;
an upstream light source for generating wavelength-locked upstream optical signals; and
a second polarization selective coupler for outputting the downstream optical signals demultiplexed by the remote node to the corresponding downstream light detector and for outputting the upstream optical signals generated by the upstream light source to the remote node.
